(19) United States
(12) Patent Application Publication
(10) Pub. No.: US 2007/0089534 A1
(43) Pub. Date: Apr. 26, 2007

(54) Testing instrument for power steering wheel shaft

(76) Inventor: Kun-Chi Chang, Lunbei Township (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/399,258

(22) Filed: Apr. 6, 2006

(30) Foreign Application Priority Data
Oct. 7, 2005 (TW) 94217462

(51) Int. Cl. G01L 3/00

(52) U.S. Cl. 73/862.08

(57) ABSTRACT

A testing instrument includes a work table, a hydraulic pipe, a positioning device, a power steering wheel shaft mounted on the positioning device and provided with a pull lever and a torque lever, a torque device provided with a universal joint connected to the torque lever of the power steering wheel shaft, and a connecting mechanism connected to the hydraulic pipe and the pull lever of the power steering wheel shaft. Thus, the testing instrument that is operated to test the torque values and tension values of the power steering wheel shaft simultaneously so as to calibrate the normal torque values and tension values of the power steering wheel shaft, thereby enhancing the manipulation performance of a power steering wheel which is connected to the power steering wheel shaft.

### BACKGROUND OF THE INVENTION

1. Field of the Invention

The present invention relates to a testing instrument and, more particularly, to a testing instrument for a power steering wheel shaft of a power steering wheel.

2. Description of the Related Art

A power steering wheel is provided with a power steering wheel shaft which is used to control connection and manipulation between the power steering wheel and the wheels by a pump and a hydraulic oil system. However, the power steering wheel shaft is easily inoperative during a long-term utilization, so that the power steering wheel fails, thereby greatly causing danger to the driver when driving the car. Thus, it is necessary to provide a testing instrument to test and calibrate the normal torque values and tension values of the power steering wheel shaft so as to enhance the manipulation performance of the power steering wheel shaft and the power steering wheel.

### BRIEF SUMMARY OF THE INVENTION

In accordance with the present invention, there is provided a testing instrument, comprising a work table, a hydraulic pipe mounted in the work table, a positioning device mounted on the work table, a power steering wheel shaft mounted on the positioning device and provided with a pull lever and a torque lever, a torque device provided with a universal joint connected to the torque lever of the power steering wheel shaft, and a connecting mechanism mounted on the work table and connected to the hydraulic pipe and the pull lever of the power steering wheel shaft.

The primary objective of the present invention is to provide a testing instrument for a power steering wheel shaft.

Another objective of the present invention is to provide a testing instrument that is operated to test the torque values and tension values of the power steering wheel shaft simultaneously so as to calibrate the normal torque values and tension values of the power steering wheel shaft, thereby enhancing the manipulation performance of a power steering wheel which is connected to the power steering wheel shaft.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a testing instrument in accordance with the preferred embodiment of the present invention.

FIG. 2 is a partially exploded perspective view of the testing instrument as shown in FIG. 1.

FIG. 3 is a schematic front plan operational view of the testing instrument as shown in FIG. 1.

FIG. 4 is a schematic front plan operational view of the testing instrument as shown in FIG. 1.

FIG. 5 is a perspective operational view of the testing instrument as shown in FIG. 1.

FIG. 6 is a perspective view of a testing instrument in accordance with another preferred embodiment of the present invention.

FIG. 7 is a schematic view showing a hydraulic circulation system of the testing instrument as shown in FIG. 1.

FIG. 8 is a schematic view showing a hydraulic pipe of the testing instrument as shown in FIG. 1.

### DETAILED DESCRIPTION OF THE INVENTION

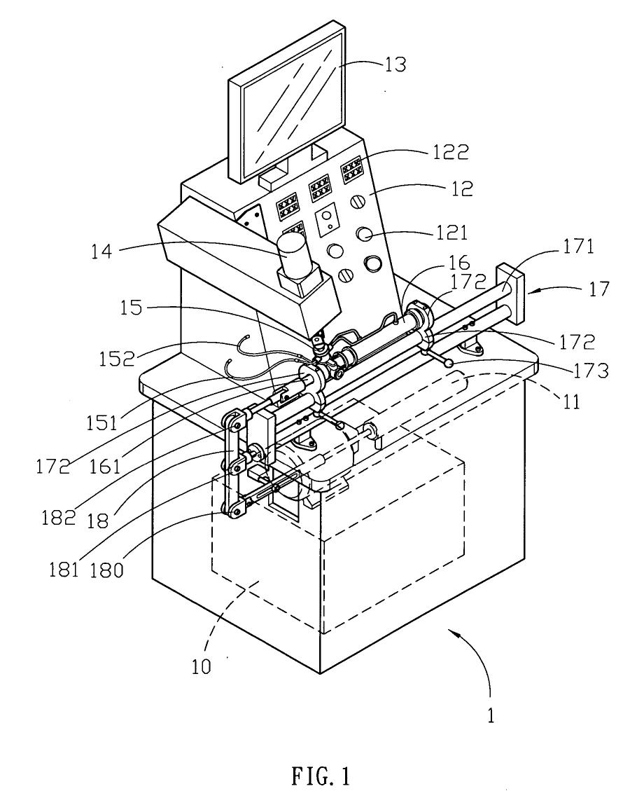

Referring to the drawings and initially to FIGS. 1-3, a testing instrument in accordance with the preferred embodiment of the present invention comprises a work table 1, a hydraulic pipe 11 mounted in the work table 1, a positioning device 17 mounted on the work table 1, a power steering wheel shaft 16 mounted on the positioning device 17 and provided with a pull lever 161 and a torque lever 162, a torque device 14 mounted on the controller 12 and provided with a universal joint 15 connected to the torque lever 162 of the power steering wheel shaft 16, an oil inlet pipe 151 and an oil outlet pipe 152 each connected between the universal joint 15 of the torque device 14 and the power steering wheel shaft 16, a pump 10 mounted in the work table 1 and connected to the oil inlet pipe 151 and the oil outlet pipe 152, and a connecting mechanism 18 mounted on the work table 1 and connected to the hydraulic pipe 11 and the pull lever 161 of the power steering wheel shaft 16.

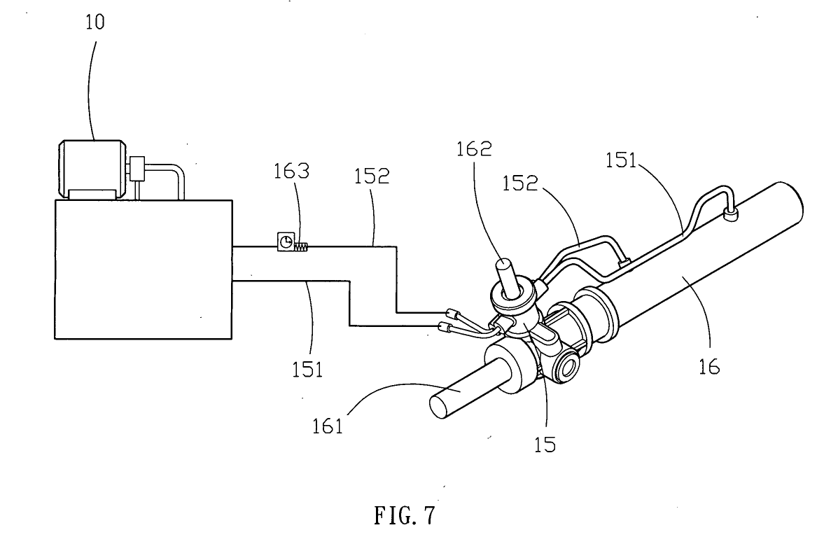

The pump 10, the universal joint 15 of the torque device 14, the oil inlet pipe 151, the oil outlet pipe 152 and the power steering wheel shaft 16 form a hydraulic circulation system as shown in FIG. 7 so that a hydraulic oil pumped by the pump 10 is circulated between the oil inlet pipe 151, the power steering wheel shaft 16 and the oil outlet pipe 152.

A controller 12 is mounted on the work table 1 and connected to the torque device 14 to control operation of the universal joint 15 of the torque device 14. The controller 12 is mounted on a first side of the work table 1 and provided with a plurality of control buttons 121 and a plurality of number indicators 122. A monitor 13 is mounted on a top face of the controller 12. The pump 10 is driven by the controller 12. The torque device 14 is mounted on a side of the controller 12. The universal joint 15 of the torque device 14 is mounted on a bottom of the torque device 14.

The positioning device 17 is mounted on a second side of the work table 1 and includes a support member 171 mounted on the work table 1, two clamping members 172 movably mounted on the support member 171 to clamp the power steering wheel shaft 16, and two fastening members 173 each mounted on a respective one of the clamping members 172 and each connected to the support member 171 to lock and unlock the respective clamping member 172. The pull lever 161 of the power steering wheel shaft 16 is clamped by one of the clamping members 172 of the positioning device 17 as shown in FIG. 1.

The connecting mechanism 18 has a first end provided with a first pivot member 180 connected to the hydraulic pipe 11, a mediate portion provided with a second pivot member 181 connected to the positioning device 17 and a second end provided with a third pivot member 182 connected to the pull lever 161 of the power steering wheel shaft 16. Preferably, the second pivot member 181 of the connecting mechanism 18 is connected to a side of the support member 171 of the positioning device 17.

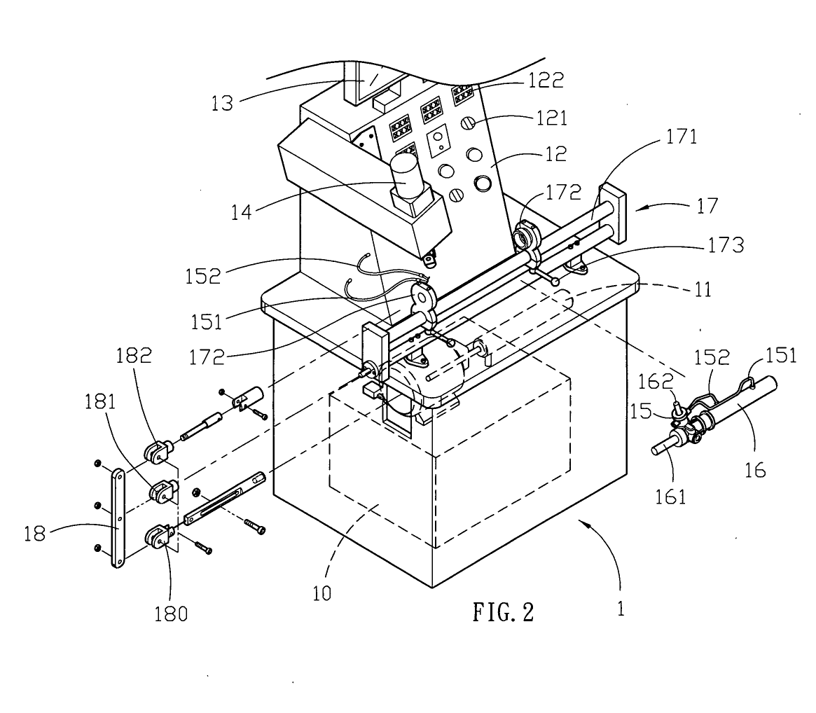

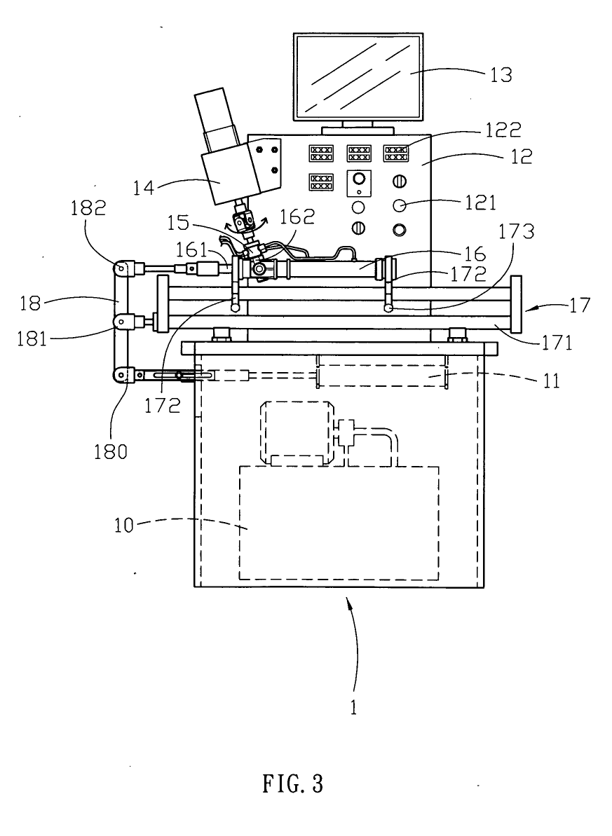

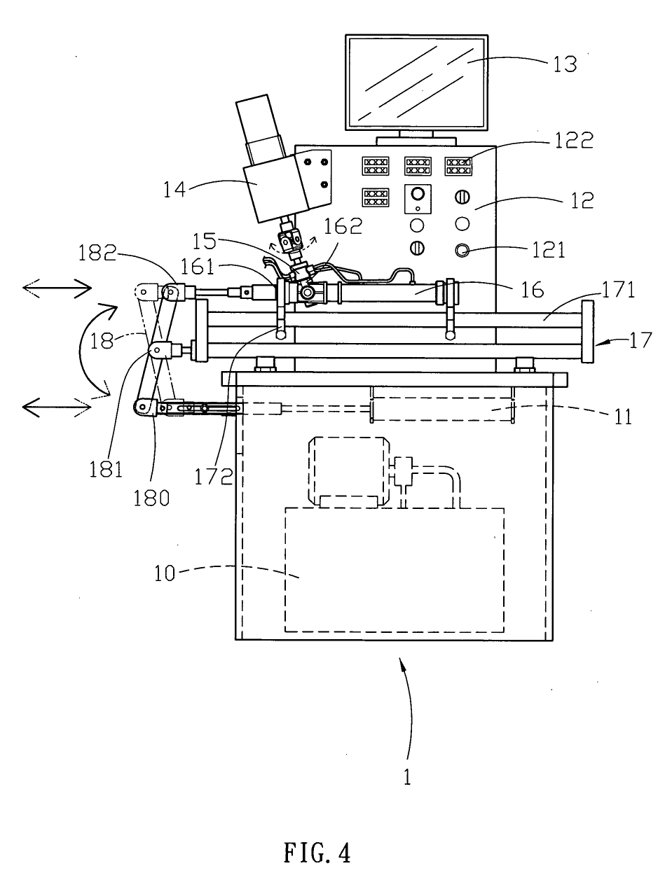

In operation, referring to FIGS. 3 and 4 with reference to FIGS. 1 and 2, when the pump 10 is driven by the controller 12, the pump 10, the universal joint 15 of the torque device 14, the oil inlet pipe 151, the oil outlet pipe 152 and the power steering wheel shaft 16 form a hydraulic circulation system so that the hydraulic oil pumped by the pump 10 is circulated between the oil inlet pipe 151, the power steering wheel shaft 16 and the oil outlet pipe 152. At this time, the universal joint 15 of the torque device 14 is driven by the controller 12 to rotate the torque lever 162 of the power steering wheel shaft 16 as shown in FIG. 3 so as to test the torque values of the power steering wheel shaft 16. At the same time, the connecting mechanism 18 is driven by the hydraulic pipe 11 to push or pull the pull lever 161 of the power steering wheel shaft 16 as shown in FIG. 4 so as to test the tension values of the power steering wheel shaft 16. Thus, the testing instrument is operated to test the torque values and tension values of the power steering wheel shaft 16 simultaneously so as to calibrate the normal torque values and tension values of the power steering wheel shaft 16, thereby enhancing the manipulation performance of a power steering wheel which is connected to the power steering wheel shaft 16.

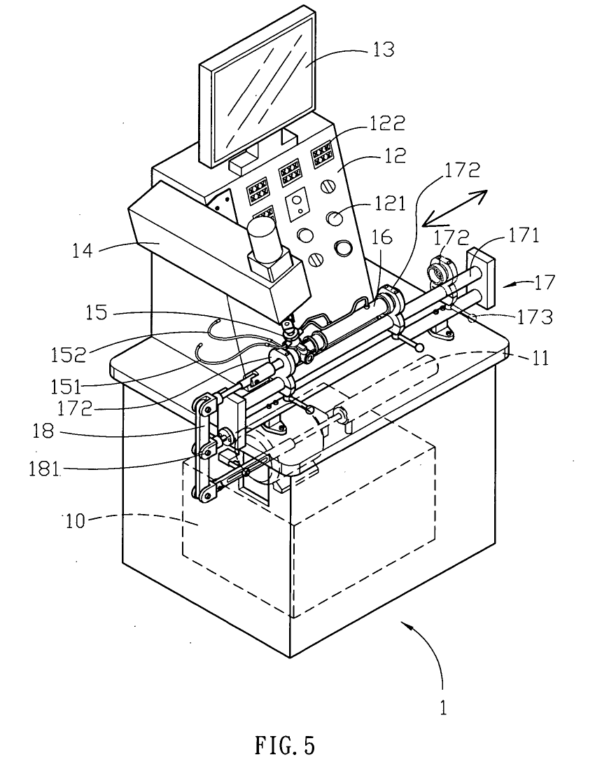

As shown in FIG. 5, one of the clamping members 172 of the positioning device 17 is freely movable on the support member 171 after the respective fastening member 173 is unlocked to adjust the distance between the clamping members 172 of the positioning device 17 so as to fit the size of the power steering wheel shaft 16.

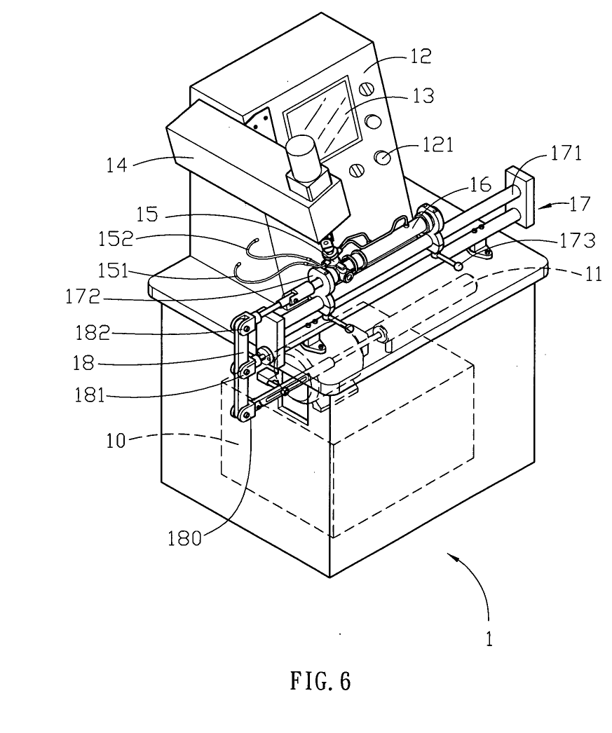

As shown in FIG. 6, the monitor 13 is mounted in the controller 12 to reduce the volume of the testing instrument.

As shown in FIG. 7, a pressure regulating valve 163 is mounted between the pump 10 and either one of the oil inlet pipe 151 and the oil outlet pipe 152. In the preferred embodiment of the present invention, the pressure regulating valve 163 is mounted between the pump 10 and the oil outlet pipe 152.

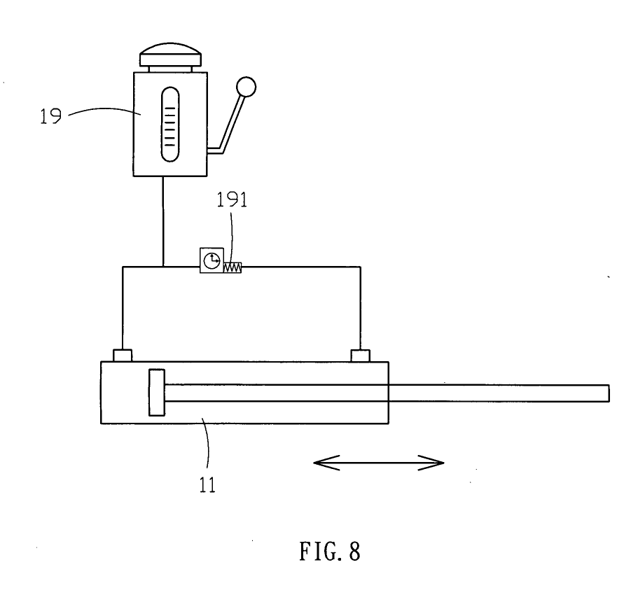

As shown in FIG. 8, the hydraulic pipe 11 is driven by a second pump or an oil tank 19, and a pressure regulating valve 191 is mounted between the hydraulic pipe 11 and the oil tank 19.

Accordingly, the testing instrument is operated to test the torque values and tension values of the power steering wheel shaft 16 simultaneously so as to calibrate the normal torque values and tension values of the power steering wheel shaft 16, thereby enhancing the manipulation performance of a power steering wheel which is connected to the power steering wheel shaft 16.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A testing instrument, comprising:
a work table;
a hydraulic pipe mounted in the work table;
a positioning device mounted on the work table;
a power steering wheel shaft mounted on the positioning device and provided with a pull lever and a torque lever;
a torque device provided with a universal joint connected to the torque lever of the power steering wheel shaft;
a connecting mechanism mounted on the work table and connected to the hydraulic pipe and the pull lever of the power steering wheel shaft.

2. The testing instrument in accordance with claim 1, further comprising an oil inlet pipe and an oil outlet pipe each connected between the universal joint of the torque device and the power steering wheel shaft.

3. The testing instrument in accordance with claim 2, further comprising a pump mounted in the work table and connected to the oil inlet pipe and the oil outlet pipe.

4. The testing instrument in accordance with claim 3, wherein the pump, the universal joint of the torque device, the oil inlet pipe, the oil outlet pipe and the power steering wheel shaft form a hydraulic circulation system.

5. The testing instrument in accordance with claim 1, further comprising a controller mounted on the work table and connected to the torque device to control operation of the universal joint of the torque device.

6. The testing instrument in accordance with claim 5, wherein the controller is provided with a plurality of control buttons and a plurality of number indicators.

7. The testing instrument in accordance with claim 5, further comprising a monitor mounted on a top face of the controller.

8. The testing instrument in accordance with claim 5, wherein the pump is driven by the controller.

9. The testing instrument in accordance with claim 5, wherein the torque device is mounted on a side of the controller.

10. The testing instrument in accordance with claim 5, wherein the controller is mounted on a first side of the work table, and the positioning device is mounted on a second side of the work table.

11. The testing instrument in accordance with claim 1, wherein the universal joint of the torque device is mounted on a bottom of the torque device.

12. The testing instrument in accordance with claim 1, wherein the positioning device includes a support member mounted on the work table, and two clamping members movably mounted on the support member to clamp the power steering wheel shaft.

13. The testing instrument in accordance with claim 12, wherein the positioning device further includes two fastening members each mounted on a respective one of the clamping members and each connected to the support member to lock and unlock the respective clamping member.

14. The testing instrument in accordance with claim 12, wherein the pull lever of the power steering wheel shaft is clamped by one of the clamping members of the positioning device.

15. The testing instrument in accordance with claim 1, wherein the connecting mechanism has a first end provided with a first pivot member connected to the hydraulic pipe, a mediate portion provided with a second pivot member connected to the positioning device and a second end provided with a third pivot member connected to the pull lever of the power steering wheel shaft.

16. The testing instrument in accordance with claim 5, further comprising a monitor mounted in the controller.

17. The testing instrument in accordance with claim 3, further comprising a pressure regulating valve mounted between the pump and either one of the oil inlet pipe and the oil outlet pipe.

18. The testing instrument in accordance with claim 1, wherein the hydraulic pipe is driven by an oil tank.

19. The testing instrument in accordance with claim 18, further comprising a pressure regulating valve mounted between the hydraulic pipe and the oil tank.

20. The testing instrument in accordance with claim 1, wherein the universal joint of the torque device is operated to test torque values of the torque lever of the power steering wheel shaft, and the connecting mechanism is operated to test tension values of the pull lever of the power steering wheel shaft simultaneously, so that the testing instrument is operated to test torque values and tension values of the power steering wheel shaft simultaneously.
